(19) United States
(12) Patent Application Publication
(10) Pub. No.: US 2004/0109309 A1
(43) Pub. Date: Jun. 10, 2004

(54) Decorative light string with gathering bulb assemblies

(76) Inventor: Chen-Yuan Chen, Hsinchu-City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/310,896

(22) Filed: Dec. 6, 2002

(51) Int. Cl. F21S 6/00

(52) U.S. Cl. 362/122; 362/249; 362/252; 362/238

(57) ABSTRACT

The present invention relates to a decorative light string with gathering bulb assemblies, each of which includes a holder and a bulb. The holder of the bulb assembly has provided with a side connector to connect with a connecting wire of the main wire easily. So a curtain number of bulb assembly can be gathered around the main wire at a nearby position to show a gathering lighting effect for increasing special decoration conveniently.

### BACKGROUND OF THE INVENTION

A conventional decorative light string with gathering bulb assemblies is provided by arranging the electrical wires for connection to form several bulb assemblies being gathered around a main electrical wire of the string. Such as a known structure in U.S. patent Ser. No. 09/925,454, it is very difficult and troubles to arrange the connecting wire to gather some bulb assemblies at a nearby place relating to the main wire.

Accordingly, the primary object of the invention is to provide a decorative light string with gathering bulb assemblies, wherein the bulb assembly can be connected with the electrical wire easily. Several bulb assemblies can be gathered at a nearby position relating to the main wire of the string conveniently for the special decorative purpose. Now the features and advantages of the present invention will be described in detail with reference to the accompanying drawings.

### BRIEF DESCRIPTION OF ACCOMPANYING DRAWINGS

FIG. 1 is an abridged plan view showing a decorative light string with gathering bulb assemblies according to the present invention.

FIG. 2 is a perspective view showing parts of the light string of FIG. 1.

FIG. 3 is a perspective view showing a decorative ring having leaves of FIG. 1.

### DETAILED DESCRIPTION OF PREFERRED EMBODIMENTS

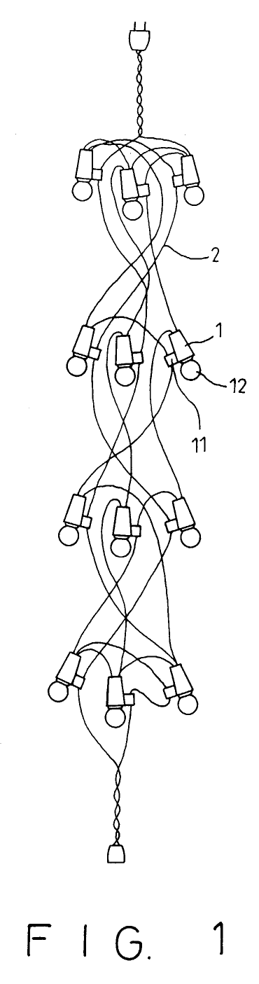

Please refer to FIG. 1 firstly, the present invention relates to a decorative light string with gathering bulb assemblies, which includes a main wire (1) composed by several connecting electrical wires and many bulb assemblies. Each bulb assembly includes a holder (1) and a bulb (12).

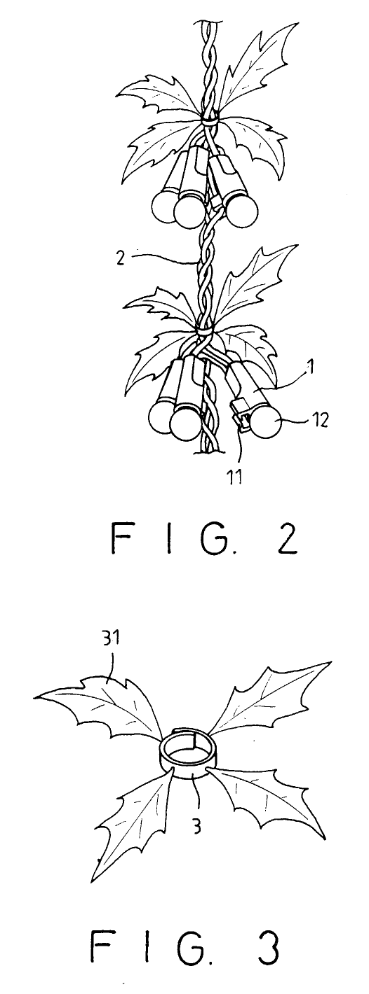

The characteristic of the present invention is that the holder (1) is provided with a side connector (11), which can engage with a connecting wire of the main wire (2) in ease. Hence, a curtain number of bulb assembly can be gathered around the main wire (2) at a nearby position, as shown in FIG. 2. It shows a gathering lighting effect for special decoration.

Referring to FIG. 3, a decorative ring (3) having outward extended leaves is possible to be provided. The ring (3) has overlapped free ends, which can be separated to elastically connect around the main wire (1) for increasing decorative effect.

Accordingly, the present invention provides the bulb assembly being connected with the main wire of the light string easily to provide a gathering lighting effect. It obviously achieves utility and improvement and should be allowed for patent.

What is claimed is:

1. A decorative light string with gathering bulb assemblies including a main wire composed by several connecting electrical wires and many bulb assemblies and each bulb assembly including a holder and a bulb; the characteristic is that the holder being provided with a side connector, which can engage with a connecting wire of the main wire in ease to form a curtain number of bulb assembly being gathered around the main wire at a nearby position and to show a gathering lighting effect for special decoration.

2. The decorative light string with gathering bulb assemblies, wherein a decorative ring having outward extended leaves is possible to be provided, which has overlapped free ends being possibly separated to elastically connect around the main wire.
